(19) United States
(12) Patent Application Publication
(10) Pub. No.: US 2014/0279946 A1
(43) Pub. Date: Sep. 18, 2014

(54) System and Method for Automatic Integrity Checks in a Key/Value Store

(71) Applicant: FUTUREWEI TECHNOLOGIES, INC., Plano, TX (US)

(72) Inventors: Anthony Scarpino, Mountain View, CA (US); James Hughes, Palo Alto, CA (US)

(73) Assignee: FutureWei Technologies, Inc., Plano, TX (US)

(21) Appl. No.: 13/797,487

(22) Filed: Mar. 12, 2013

(51) Int. Cl. G06F 17/30

(52) U.S. Cl. CPC G06F 17/30371
USPC 707/691

(57) ABSTRACT

System and method embodiments are provided for integrity check and recovery in a key/value store. An embodiment method includes receiving a command to retrieve a data block stored in the key-value store system, the command indicating a key associated with the data block. The method further includes retrieving one or more copies of the stored data block including the key, a value, a data integrity check algorithm, and an integrity value, and performing data integrity check on the retrieved one or more copies of the data block using the data integrity check algorithm, the integrity value, and at least one of the key and the value. Upon one or more copies of the data block failing the data integrity check, the one or more copies of the data block are repaired and the data block is delivered.

### TECHNICAL FIELD

The present invention relates to storage technology, and, in particular embodiments, to a system and method for automatic integrity checks in a key/value store.

### BACKGROUND

In some storage systems, such as distributed hash table (DHT), key/value store, and noSQL database systems, data is stored in the form of data objects, where each object includes a key and value. The key is used to identify the data object, and the value represents the data content. A data object may correspond to a single data structure or a set of data (e.g., a file or a set of files). Alternatively, the data object may correspond to a block or chunk of data, such as a portion of a file or a file from a set of files. The stored data integrity can be compromised when the data is changed or corrupted due to hardware failure, a malicious attack (e.g., by a hacker), or other reasons.

For some storage or database systems, a mechanism can be included to check the integrity of stored data. The mechanism includes associating each individual data block in a database with a corresponding message digest. The message digest is a signature that describes the uniqueness of the corresponding data block. A message digest algorithm can be used for examining the message digest of a data block to check the block integrity. The algorithm ensures that the data has not been modified or corrupted. The data that fails the block integrity check is identified to prevent the delivery of such data to a user, e.g., by disregarding such data. However, there is a need for a mechanism in a key/value store, or similar systems that store data objects with a key and value, to deliver the correct data to the user when the integrity check fails.

### SUMMARY OF THE INVENTION

In accordance with an embodiment, a method for data integrity check and recovery in a key-value store system includes receiving a command to retrieve a data block stored in the key-value store system, the command indicating a key associated with the data block, retrieving one or more copies of the stored data block including the key, a value, a data integrity check algorithm, and an integrity value, and performing data integrity check on the retrieved one or more copies of the data block using the data integrity check algorithm, the integrity value, and at least one of the key and the value. The method also includes, upon one or more copies of the data block failing the data integrity check, repairing the one or more copies of the data block and delivering the data block.

In accordance with another embodiment, a method for data storage supporting data integrity check and recovery in a key-value store system includes receiving a command to store a data block in the key-value store system, the data block including a key identifying the data block and a value representing data content, calculating an integrity value for the data block using a data integrity check algorithm, adding the calculated integrity value and the data integrity check algorithm to the data block, and storing one or more copies of the data block including the key, the value, the data integrity check algorithm, and the integrity value in one or more storage nodes of the key-value store system.

In accordance with yet another embodiment, in a storage system, an apparatus for data storage supporting data integrity check and recovery in a key-value store system includes one or more storage nodes configured for storing one or more data blocks including key and value pairs, a processor, and a computer readable storage medium storing programming for execution by the processor. The programming includes instructions to receive a command to retrieve a data block stored at the one or more storage nodes, the command indicating a key associated with the data block, retrieve one or more copies of the stored data block including the key, a value, a data integrity check algorithm, and an integrity value, and perform data integrity check on the retrieved one or more copies of the data block using the data integrity check algorithm, the integrity value, and at least one of the key and the value. Upon one or more copies of the data block failing the data integrity check, the one or more copies of the data block are repaired and the data block is delivered.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an embodiment of a put operation for a key/value store system;

FIG. 2 illustrates an embodiment of a get operation for a key/value store system;

FIG. 3 is an embodiment of an integrity check and recovery method for a key/value store system;

FIG. 4 is a processing system that can be used to implement various embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

System and method embodiments are provided for integrity check and recovery in a key/value store. The system and method embodiments can also be implemented for any storage system that stores data objects including key and value pairs, such as DHT and noSQL database systems. The embodiments include calculating a block integrity value for a key and value pair and storing the integrity value with the key and value pair in one or more storage nodes. Multiple copies can be stored at different locations or nodes. Upon retrieving the stored data for a user from one or more storage nodes, the integrity value is recalculated for each retrieved key and value pair and compared with the previously stored integrity value of the retrieved key and value pair to check data integrity. The integrity value can be calculated using the message digest algorithm.

A copy passes the integrity check when the two integrity values match and hence the copy can be forwarded to the user. A copy that fails the integrity check (upon detecting a mismatch between the two integrity values) is repaired and then stored and can be forwarded to the user if needed. The corrupted or changed data can be repaired using any suitable data recovery or repair mechanism, for example using one or more other stored copies that are not corrupted (e.g., that pass the integrity check). The schemes herein allow the storage system to check each storage node for data integrity and repair failures for any storage node that fails the integrity check to guarantee delivering a correct or intact version of the requested data to the user. The schemes also guarantee delivering the correct value associated with the key provided by the user.

FIG. 1 shows an embodiment of a put operation 100 for a key/value store system. The key/value store system includes a plurality of storage nodes 130 configured to store data objects including key/value pairs. Examples of a storage node 130 include as a hard disk, a flash memory card, a random access memory (RAM) device, a universal serial bus (USB) flash drive, or any other suitable storage device. In an embodiment, the storage nodes 130 have a sea of disk (SoD) topology, which is suitable for providing data storage for cloud computing purposes. According to the SoD topology, each storage nodes 130 is a case that includes a plurality of disks. The disks may comprise a plurality of ATOM, ARM, and/or other processor type based computers. Each of the computers may also comprise other components, such as a Central Processing Unit (CPU), a random access memory (RAM), a Flash/Solid State Drive (SSD), a HDD, a one Gigabit per second (1 G) Ethernet card, or combinations thereof. The key/value store system may be a localized or centralized storage system (e.g., in a data center), or alternatively a remote or distributed system across the Internet, other network, and/or multiple data centers.

The key/value store system is configured to store (in the storage nodes 130) data objects or blocks 110, each including a key 102 and a value 104. A block integrity value 108 and a block integrity algorithm 107 used for calculating the integrity value 108 can also be included in a field 106 in the data block 110. To store the data block 110, a user (or the system) can initiate the put operation 100, for example using a put command or function that includes the data block 110 with the key 102 and the value 104 (without the algorithm 107 and the integrity value 108).

Upon receiving the command and the data block 110, the system uses a message digest algorithm to calculate the integrity value 108, e.g., a message digest. The integrity value 108 can be calculated based on, for instance, the key 102, a key length 103 (of the key 102), a value 104, and a value length 105 (of the value 104). The resulting data block 120 that includes the block integrity algorithm 107 and the integrity value 108 is then stored in one or more storage nodes 130, where each storage node 130 stores a version or copy of the same resulting data block 110. Multiple copies can be stored in multiple storage nodes 130 to provide redundancy and resilience to errors, system failures, or data losses.

FIG. 2 shows an embodiment of a get operation 200 for a key/value store system. The get operation 200 can be implemented in the same key/value store system above (in FIG. 1). To retrieve the data block 110, a user (or the system) can initiate the get operation 200, for example using a get command or function that includes the key 102, which is used to identify the data block 110 or the value 104 to be retrieved. Upon receiving the command and the key 102, the system searches one or multiple storage nodes 130 to find the requested data block 110 or value 104. The system can retrieve one or more available copies of the stored data block 110 from one or more storage nodes 130. Each copy includes the same key 102 of the get command, the value 104, and the field 106 comprising the algorithm 107 and the integrity value 108.

The system then performs an integrity check for each retrieved copy of the data block 110. To check the data integrity, the system uses the algorithm 107 (e.g., a message digest algorithm) to calculate an integrity value (e.g., a digest message) using the information in the data blocks 110, such as the key 102 and the value 104. The calculated integrity value is then compared to the integrity value 108 in the retrieved data block 110. The data block 110 passes the integrity check if the two integrity values match. Hence, a copy of the data block 110 is forwarded to the user. If the two values do not check, the integrity check fails. The mismatch may be cause due to change or corruption in the data (e.g., in the value 104), for example due to hardware failure or other reasons. In this case, the system does not disregard or remove the corrupted data block 110. Instead, the corrupted data block 110 is repaired using a suitable recovery mechanism, for instance using a Read-Repair operation. The mechanism may use one or more other uncorrupted copies of the data block 110 that passed the integrity check to repair the corrupted copy. If the integrity check reveals only corrupted copies, the system sends a copy after repair to the user. The repaired copy can also be stored in a storage node 110 replacing the corrupted copy.

FIG. 3 shows an embodiment of an integrity check and recovery method 300 for a key/value store system. The method 300 can be used in the key/value store system, for example as part of the get operation 300, to guarantee delivering an uncorrupted data block to a user. At step 310, a get command is received including a key for a data block. At step 320, the key/value store system is searched to retrieve one or more copies of the data block that have a matching key from one or more storage nodes. At step 330, an integrity check is performed for each retrieved copy of the data block using the algorithm and integrity value included in each retrieved copy. At step 340, the method 300 verifies whether there is a corrupted copy that fails the integrity check. If the condition in step 340 is true, then the method 300 proceeds to step 350. Otherwise, the method 300 proceeds to step 360. At step 350, any corrupted copy that fails the integrity check is sent for repair, e.g., using a Read-Repair function. The repaired copy can then be stored replacing the corrupted copy. The method 300 then proceeds from step 350 to step 360. At step 360, an uncorrupted or repaired copy of the data block is delivered.

FIG. 4 is a block diagram of a processing system 400 that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 400 may comprise a processing unit 401 equipped with one or more input/output devices, such as a network interfaces, storage interfaces, and the like. The processing unit 401 may include a central processing unit (CPU) 410, a memory 420, a mass storage device 430, and an I/O interface 460 connected to a bus. The bus may be one or more of any type of several bus architectures including a memory bus or memory controller, a peripheral bus or the like.

The CPU 410 may comprise any type of electronic data processor. The memory 420 may comprise any type of system memory such as static random access memory (SRAM), dynamic random access memory (DRAM), synchronous DRAM (SDRAM), read-only memory (ROM), a combination thereof, or the like. In an embodiment, the memory 420 may include ROM for use at boot-up, and DRAM for program and data storage for use while executing programs. In embodiments, the memory 420 is non-transitory. The mass storage device 430 may comprise any type of storage device configured to store data, programs, and other information and to make the data, programs, and other information accessible via the bus. The mass storage device 430 may comprise, for example, one or more of a solid state drive, hard disk drive, a magnetic disk drive, an optical disk drive, or the like.

The processing unit 401 also includes one or more network interfaces 450, which may comprise wired links, such as an Ethernet cable or the like, and/or wireless links to access nodes or one or more networks 480. The network interface 450 allows the processing unit 401 to communicate with remote units via the networks 480. For example, the network interface 450 may provide wireless communication via one or more transmitters/transmit antennas and one or more receivers/receive antennas. In an embodiment, the processing unit 401 is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for data integrity check and recovery in a key-value store system, the method comprising:
receiving a command to retrieve a data block stored in the key-value store system, the command indicating a key associated with the data block;
retrieving one or more copies of the stored data block including the key, a value, a data integrity check algorithm, and an integrity value;
performing data integrity check on the retrieved one or more copies of the data block using the data integrity check algorithm, the integrity value, and at least one of the key and the value;
upon one or more copies of the data block failing the data integrity check, repairing the one or more copies of the data block; and
delivering the data block.

2. The method of claim 1 further comprising storing the repaired one or more copies of the data block.

3. The method of claim 1, wherein the delivered data block has passed the data integrity check or is a repaired data block.

4. The method of claim 1, wherein the integrity value is a message digest, and wherein the data integrity check algorithm is a message digest algorithm used to calculate the message digest for the data block.

5. The method of claim 1, wherein the one or more copies of the data block are stored in one or more corresponding storage nodes of the key-value store system, and wherein the repaired one or more copies of the data block are stored at the corresponding one or more storage nodes.

6. The method of claim 1, wherein the one or more copies of the data block are repaired using a Read-Repair function during processing the command to retrieve the data block or during delivering the data block.

7. The method of claim 1, wherein performing data integrity check comprises:
recalculating an integrity value using the data integrity check algorithm; and
determining whether the recalculated integrity value matches the integrity value in the retrieved one or more copies of the data block.

8. The method of claim 7, wherein the integrity value is recalculated using the key, a length of the key, the value, and a length of the value.

9. The method of claim 1, wherein the one or more copies of the data block are repaired using at least one copy of data block that has passed the data integrity check.

10. A method for data storage supporting data integrity check and recovery in a key-value store system, the method comprising:
receiving a command to store a data block in the key-value store system, the data block including a key identifying the data block and a value representing data content;
calculating an integrity value for the data block using a data integrity check algorithm,
adding the calculated integrity value and the data integrity check algorithm to the data block; and
storing one or more copies of the data block including the key, the value, the data integrity check algorithm, and the integrity value in one or more storage nodes of the key-value store system.

11. The method of claim 10, wherein the integrity value is calculated using the key, a length of the key, the value, and a length of the value.

12. The method of claim 10, wherein the integrity value is a message digest, and wherein the data integrity check algorithm is a message digest algorithm used to calculate the message digest for the data block.

13. An apparatus for data storage supporting data integrity check and recovery in a key-value store system, the apparatus comprising:
one or more storage nodes configured for storing one or more data blocks including key and value pairs;
a processor; and
a computer readable storage medium storing programming for execution by the processor, the programming including instructions to:
receive a command to retrieve a data block stored at the one or more storage nodes, the command indicating a key associated with the data block;
retrieve one or more copies of the stored data block including the key, a value, a data integrity check algorithm, and an integrity value;
performing data integrity check on the retrieved one or more copies of the data block using the data integrity check algorithm, the integrity value, and at least one of the key and the value;
upon one or more copies of the data block failing the data integrity check, repair the one or more copies of the data block; and
deliver the data block.

14. The apparatus of claim 13, wherein the programming includes further instructions to:
receive a command to store the data block in the key-value store system, the data block including the key identifying the data block and the value representing data content;
calculate the integrity value for the data block using the data integrity check algorithm, add the calculated integrity value and the data integrity check algorithm to the data block; and
store one or more copies of the data block including the key, the value, the data integrity check algorithm, and the integrity value in the one or more storage nodes.

15. The apparatus of claim 13, wherein the integrity value is calculated according to the key, a length of the key, the value, and a length of the value.

16. The apparatus of claim 13, wherein the integrity value is a message digest, and wherein the data integrity check algorithm is a message digest algorithm used to calculate the message digest for the data block.

17. The apparatus of claim 13, wherein the programming includes further instructions to store the repaired one or more copies of the data block at the one or more storage nodes.

18. The apparatus of claim 13, wherein the delivered data block has passed the data integrity check or is a repaired data block.

19. The apparatus of claim 13, wherein the programming includes further instructions to:
recalculate an integrity value using the data integrity check algorithm; and
determine whether the recalculated integrity value matches the integrity value in the retrieved one or more copies of the data block.

20. The apparatus of claim 13, wherein the programming includes further instructions to repair the one or more copies of the data block using a Read-Repair function and at least one copy of data block that has passed the data integrity check.
